(19) United States
(12) Patent Application Publication
(10) Pub. No.: US 2010/0195590 A1
(43) Pub. Date: Aug. 5, 2010

(54) METHOD AND APPARATUS FOR RADIO SPECTRUM SENSING OR MONITORING

(76) Inventor: Edwin Park, San Diego, CA (US)

Correspondence Address: Patentique PLLC, P.O. Box 5803, Bellevue, WA, 98006, US

(21) Appl. No.: 12/651,363

(22) Filed: Dec. 31, 2009

Related U.S. Application Data
(60) Provisional application No. 61/149,925, filed on Feb. 4, 2009.

(51) Int. Cl. H04W 24/00

(52) U.S. Cl. 370/329

(57) ABSTRACT

There is provided a system and method of sensing a radio frequency channel to determine activity, determining location, mapping location to existing radio frequency licenses, determining the radio frequency channel to be available and sharing that the radio frequency channel is available. Systems implementing this method may use a single device to perform the method steps or may use several different devices to share the complexity and workload associated with the method. This method is applicable to white space radio and to cognitive radio.

### FIELD OF THE INVENTION

This non-provisional application claims benefit of priority from U.S. Provisional Application No. 61/149,925, filed Feb. 4, 2009, which is hereby incorporated by reference in its entirety as if fully set forth.

The present invention relates to methods and apparatuses for radio spectrum sensing and spectrum monitoring and is particularly concerned with determining spectrum availability by radio spectrum sensing and radio spectrum monitoring.

### BACKGROUND OF THE INVENTION

Radio spectrum is scarce and valuable. We can see the demand and value of such spectrum in the recent auctions of spectrum for billions of dollars. Furthermore, not all spectrums are equivalent. For example, spectrum at lower frequencies, all things being equal, penetrates walls better and propagates further at the same power. Moreover, the current spectrum map is fragmented as a result of legacy assignments. Therefore, unassigned spectrum is not easily available.

One vast bandwidth on the spectrum map is the broadcast bands. Broadcast bands include, but are not limited to, the television and radio bands. With the movement of analog television stations to digital, white space communications is opening up. The proposed white space communication schemes involve sensing the spectrum to verify that a licensed service such as broadcast from a television station or a wireless microphone system is not operating in the frequency/channel. Then the devices can utilize this frequency/channel to communicate. The pundits predict a wide range of devices to utilize this band. Furthermore, much like white space, cognitive radio will utilize resources/spectrum (i.e. frequency or frequency/time) in licensed bands that are not used. Cognitive radios can go further and allocate a resource. This resource can be a frequency/channel or frequency/channel for a period of time.

The advantage of the white space devices is that a large swath of spectrum at a relatively low frequency (i.e. better penetration of walls vs. 2.4 GHz) may be available. The disadvantage associated with these devices is that unlike allocated spectrum (e.g. auctioned spectrum), the underutilized spectrum is not centrally controlled by a carrier. Therefore, sensing and monitoring technology must be implemented to prevent the white space device from occupying and interfering with incumbent devices (i.e. television, wireless microphones). Current proposal requires these white space devices to make sure the spectrum is not being utilized by a licensed device (spectrum detection), determine location (geo-location), and confirm with a database of licensed service (common database lookup). After the functions of spectrum sensing have been performed, the channel is available for the white space device to transmit. Furthermore, the white space device is required to continue to monitor (spectrum monitoring) the spectrum for the appearance of new licensed services and then cease termination or to move to another available frequency/channel. For example, after a white space system senses the spectrum to verify that it is available, the system may begin to communicate. After some time, a licensed wireless microphone begins to transmit. It is imperative that the white space system ceases operations in that band. The system can restart in another available band.

Systems and methods disclosed herein provide a communication system for monitoring spectrum to obviate or mitigate at least some of the aforementioned disadvantages.

### SUMMARY OF THE INVENTION

An object of the present invention is to provide improved methods and apparatuses for radio spectrum monitoring.

Accordingly, the present invention provides shared spectrum sensing or shared spectrum monitoring that allows devices to utilize licensed resources that would not be available without performing the full functions of spectrum sensing or spectrum monitoring.

In accordance with an aspect of the present invention there is provided a system comprising a first device having a radio frequency channel activity detector, a locator, database access and a communications link to at least a second device and messaging module for generating a message to the second device when a vacant radio frequency channel is identified.

In accordance with an aspect of the present invention there is provided a system comprising a first device having at least one of a radio frequency channel activity detector, a locator, database access and a communications link to at least a second device, a second device having at least complementary ones of a radio frequency channel activity detector, a locator, database access, at least one of the first and second devices having a messaging module for generating a message to any predetermined devices when a vacant radio frequency channel is identified.

In accordance with an aspect of the present invention there is provided a system comprising a group of devices including first, second and third devices, the first device having at least one of a radio frequency channel activity detector, a locator, database access and a communications link to at least a second device, a second device having at least a complementary one of a radio frequency channel activity detector, a locator, database access, a third device having at least a complementary one of a radio frequency channel activity detector, a locator, database access, at least one of the first, second and third devices having a messaging module for generating a message to any predetermined devices when a vacant radio frequency channel is identified.

In accordance with another aspect of the present invention there is provided a method comprising sensing a radio frequency channel to determine activity, determining location, mapping location to existing radio frequency licenses, determining the radio frequency channel to be available and sharing that the radio frequency channel is available. The present invention enables some new, efficient and cost effective ways for construction of cognitive radio networks, where spectrum sensing and monitoring are essential and are usually performed by each of the devices or network nodes. More specifically, a centralized or distributed sensing and monitoring method can be used in such networks.

The present invention also allows for the reduced cost or complexity to perform the spectrum sensing or spectrum monitoring function required for white space devices or cognitive radio devices and the associated networks. Furthermore, the invention can also enables for the acceleration of the spectrum sensing function.

The present invention can be implemented in either a centralized or a distributed means. The invention can allow for devices which do not participate in the spectrum sensing/monitoring functions to receive the information or results from these functions.

The present invention of shared spectrum sensing or shared spectrum monitoring allows for the sharing of the functions required in spectrum sensing or spectrum monitoring.

Although the functions can occur on a plurality of devices in some embodiments, the preferred embodiment is for these functions to occur on one device.

An example of this invention is a system that includes a home base unit with a plurality of devices. The home base unit provides the functions of spectrum sensing and spectrum monitoring. Since the devices are all within the communicating area of the home base unit (an example of a system where the shared spectrum sensing or shared spectrum monitoring is centralized), the proximity where the results are valid covers the devices. The home base unit communicates the results and coordinates with the devices to establish the frequency/channel used. Afterwards, the devices can communicate with each other or with the home base unit. Though the examples are many, these devices can a security camera and a monitor, a baby monitoring devices, smart home devices, communication devices and a television.

Another example is a decentralized or distributed shared spectrum sensing or shared spectrum monitoring system is where the functions of spectrum sensing or spectrum monitoring is shared among two or more devices. In this system, the first device performs certain functions of spectrum sensing or spectrum monitoring; another device performs certain functions; etc. These functions provided by each device may overlap. The results of these functions are communicated. The results can be the raw results to the processed results with which resource(s) to use. The available resource(s) is/are allocated/assigned/negotiated to/to/by the devices in the system. Likewise, the devices or system can continue the coordination in spectrum monitoring.

### BRIEF DESCRIPTION OF THE DRAWINGS

The present invention will be further understood from the following detailed description with reference to the drawings in which:

FIG. 1 illustrates typical white space devices;

FIG. 2 illustrates in a flow chart a typical spectrum sensing process used by the devices of FIG. 1;

FIG. 3 illustrates in in a flow chart a typical spectrum monitoring process used by the devices of FIG. 1;

FIG. 4 illustrates centralized shared spectrum sensing and monitoring process in accordance with a first embodiment of the present invention;

FIG. 5 illustrates distributed shared spectrum sensing and monitoring process in accordance with a second embodiment of the present invention;

FIG. 6 illustrates a process for shared spectrum sensing in accordance with a third embodiment of the present invention;

FIG. 7 illustrates a process for shared spectrum monitoring in accordance with a fourth embodiment of the present invention;

FIG. 8 illustrates an example of devices with sideband channel and newly available air interface with multiple protocols;

FIG. 9 illustrates an example of devices with sideband channel and newly available air interface with one protocol;

FIG. 10 illustrates an example of a device spectrum sensing and spectrum monitoring with a wireless link used for the common database lookup; and

FIG. 11 illustrates an example of devices with a shared function of spectrum sensing and spectrum monitoring.

### DETAILED DESCRIPTION OF THE PREFERRED EMBODIMENT

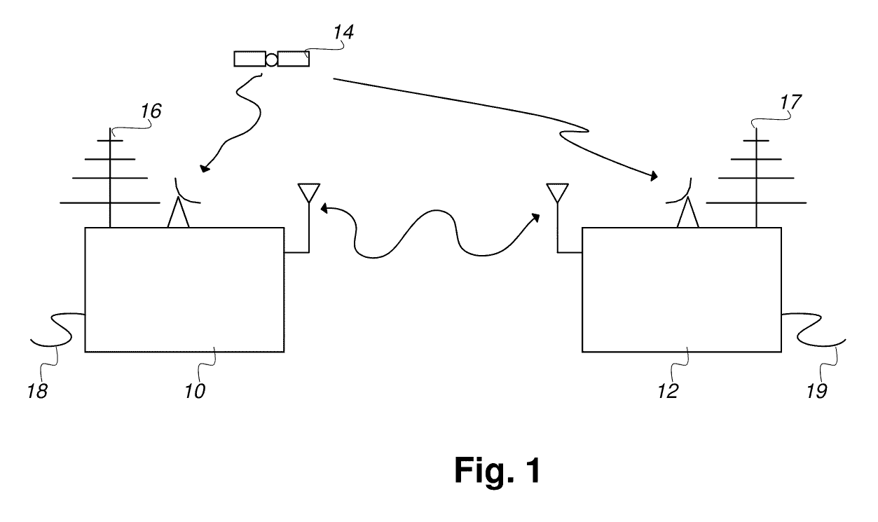

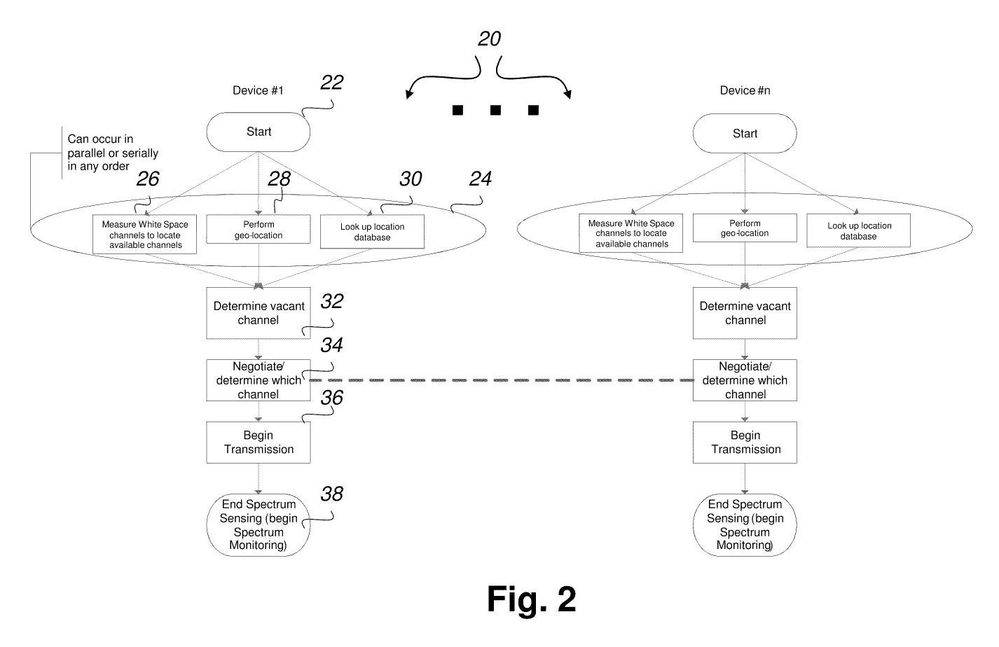

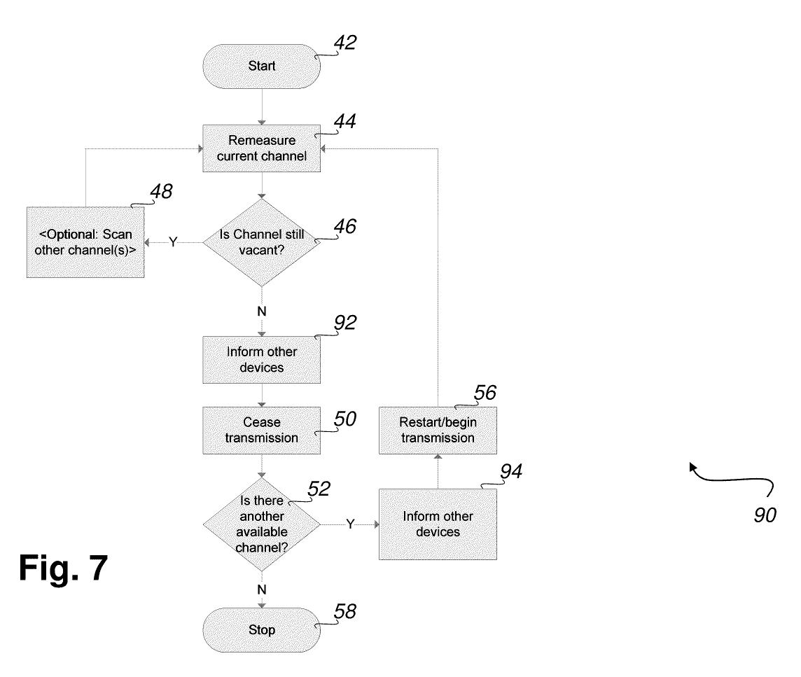

White space devices need to implement an extremely sensitive spectrum sensing technology (e.g. listen before talking). Examples are shown in FIG. 1 and FIG. 2. This spectrum sensing technology detects the presence of a licensed service and determines if the channel can be used (i.e. vacant). Also, if a licensed service starts to operate (i.e. wireless microphone) on a previously available channel (i.e. vacant), the device needs to sense the change and immediately vacate the channel (see FIG. 7).

Referring to FIG. 1 there are illustrated typical white space devices. In this figure, two devices 10 and 12 are completing the spectrum sensing function independently and then communicate with each other. In this example, the devices 10 and 12 are equivalent. In this example, the spectrum detection is on the TV band, geo-location is performed using GPS 14, spectrum sensing/monitoring uses TV antennas 16 or 17 and a common database lookup is performed over a wired connection 18 or 19. Although shown with this example any permutation of ways of performing these functions or variety of functions is equally valid.

Referring to FIG. 2 there is illustrated in a flow chart a typical spectrum sensing process used by the devices of FIG. 1. This figure is an example of the flow 20 of a typical system shown in FIG. 1 as it performs the spectrum sensing function. After starting 22 white space process steps 24 including measuring channels 26, performing geolocation 28 and doing a database location lookup 30. Determining the vacant channel 32 can involve an algorithm to determine which channel(s) to use. Negotiation with another device determines 34 which channel to use. The transmission 36 of the information can include certain messaging and protocol. However spectrum monitoring 38 continues to ensure that the channel may continue to be used.

Currently, the spectrum sensing technology needs multiple components. One is a spectrum detection function to determine which frequencies/channels are available. Another component is a geo-location function. The third function is a common database containing a list of devices at the various frequencies (i.e. channels). A common geo-location device can be GPS. The common database can be stored on line to facilitate updates to that database. The detection and geo-location and database lookup functions can occur concurrently, in series, or in any order. When the detector detects an available channel, the geo-location detects the location that the database clears as an available channel. The white space device is now cleared to transmit on the available channel.

The quality of the results of the functions do not aid or diminish the spectrum sensing or monitoring. For example, a simpler spectrum detection function implementation that detects only the energy in the frequency/channel may result in a detection function that gives false alarm when an unlicensed service exists in the frequency/channel. Therefore, it would invalidate many frequency/channels that would be available with a more complete spectrum detection implementation.

To utilize the potentially vast available spectrum the cost and complexity associated with the spectrum sensing and spectrum monitoring technology must be implemented. Though the examples in this application are often shown involving spectrum sensing and spectrum monitoring for white space channels, the examples are also valid with any resource (e.g. frequency/channel, time) one has to perform certain functions before being allowed to access the resource (e.g. frequency/channel, time). Although shown with the specific functions, we can generalize to more or fewer functions required to be performed before being allowed to access the resource (e.g. frequency/channel, time). Also, though shown with the specific functions, we can generalize to more or fewer functions required to be performed while accessing the resource (e.g. frequency/channel, time). Though most likely to be utilized in the same system, a system may use shared spectrum sensing without shared spectrum monitoring or vice versa.

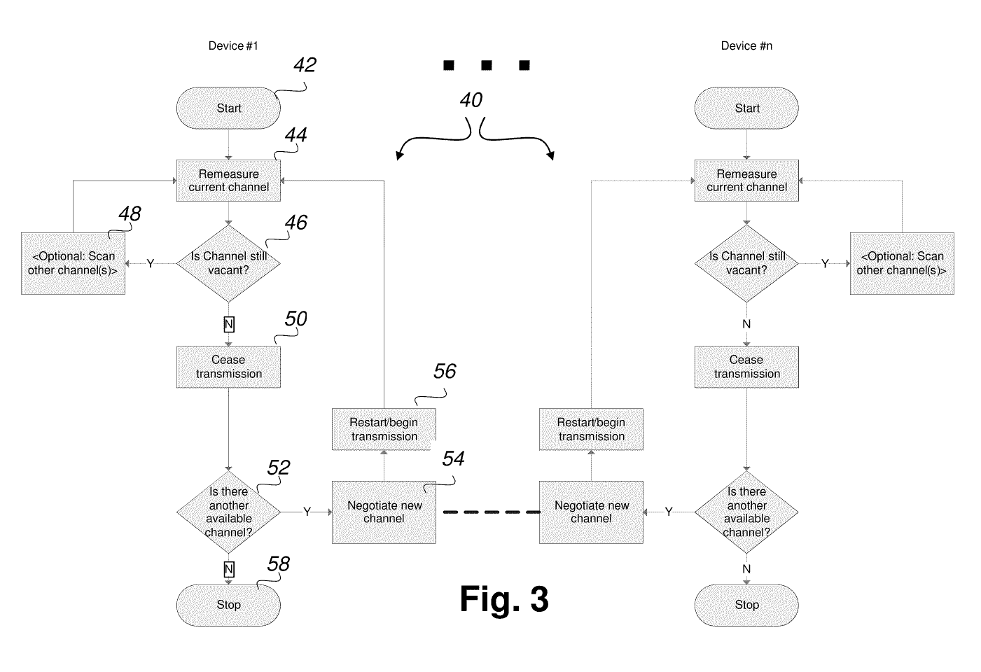

Referring to FIG. 3 there is illustrated in in a flow chart a typical spectrum monitoring process used by the devices of FIG. 1. This figure is an example of the flow 40 of a typical system shown in FIG. 1 as it performs the spectrum monitoring function 38 of FIG. 2.

After starting 42 the current channel is remeasured 44 and if YES optionally scan other channels 48. If NO transmission is ceased 50 and then it is determined if another channel is available 52. If YES the new channel is negotiated 54 and transmission is restarted 56. If NO, the process is stopped 58.

The optional step 48 in the flow 40 involves scanning other channels to measure channels that is not currently used in the transmission. These results can be useful if a licensed device begins transmission on the current channel, or if another channel can be better utilized. The flow 40 is equally valid if the optional step is skipped.

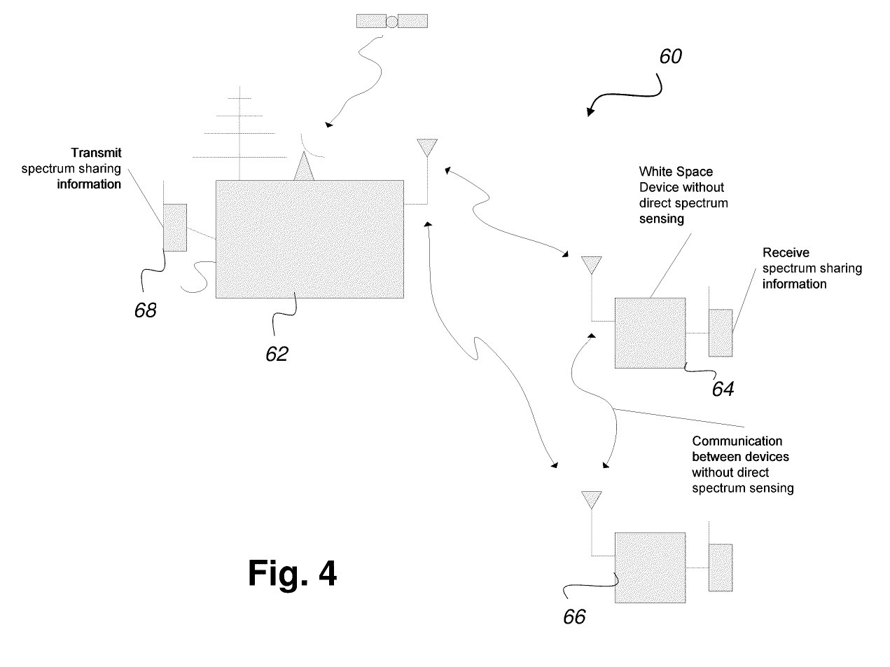

Referring to FIG. 4 there is illustrated a centralized shared spectrum sensing and monitoring process in accordance with a first embodiment of the present invention. This figure is an example of a system 60 utilizing shared spectrum sensing and spectrum monitoring. In this example, one device performs 62 the spectrum detection, geo-location, and common database lookup functions and then informs the results to the other devices 64 and 66 via a sideband channel 68. The sideband channel 68 is any way of communication except the channels that the device is sensing and including wired or wireless channels. Examples are Wi-Fi, cellular, or any available channel (e.g. white space channel on a different available carrier).

In one example, a cellular terminal is used to communicate to the other device via control channel, traffic channel, or short message service. Although shown with these examples any permutation of ways to perform spectrum sensing and communications, any ways to perform these functions are equally valid. The device that does the detection does not necessarily have to participate in the traffic (i.e. network) after the vacant channel is detected and communicated. The results of spectrum sensing and spectrum monitoring are valid for a localized proximity. Devices connected via a LAN (e.g. Wi-Fi) are bound by distance and under the localized proximity.

Furthermore, devices or the system can determine their proximity and location by other means (e.g. cellular basestation, overhead messages). Any other means, to determine that the devices are in local proximity are equally valid. For example, a home base unit can perform the channel measurement and the geo-location. Furthermore, the home base unit can have an internet connection to access the location database. Since all devices are communicating to the home base unit, they will be in a local proximity. After communicating with the devices (e.g. a security camera and a security monitor), the home base unit will not have to be part of the traffic between the devices (e.g. camera and monitor) associated with the home base unit.

The communicating of the vacant channel can also occur on the white space. Since the devices that determine the available channel will know which channel is available, the device can transmit with a pre-determined pattern on that channel after receiving/determining the results of the spectrum sensing. This transmission will be a beacon. The “listening” devices then need to monitor the entire available channel to see this beacon. If the beacon is detected, the “listening” device can now transmit on this channel and the devices will now be paired. The algorithm for the “listening” device can be as simple as the device cycling through all the available channels.

Moreover, all the devices do not have to use the same means of communication. As long as the coordination information is sent and received, the shared spectrum sensing can occur. For example, one device can use a physical wire, and another can use wireless with a central device perform the spectrum sensing.

Furthermore, embodiments of the present invention can also be utilized to monitor for new licensed devices appearing on the channel. An example flow is shown in FIG. 7. When detected, it can use the same mechanism to update the other devices. The devices can also use any other available connection to update the other devices.

Furthermore, embodiments of the present invention can also be used to determine which channel would be more appropriate for the devices to occupy. One example is to inform the devices using this scheme to move to a channel with a lower interference level. Since the device embodying the present invention continues to monitor for new licensed devices, it also has the capability to measure the interference on the channels as it conducts the scan. Therefore, if a channel is available that is more appropriate or advantageous (e.g. less noise), the system can inform the communicating devices to relocate to that channel.

Also, embodiments of the present invention can be used to move the devices to frequencies to allow a larger contiguous band to be made available for other services. For example, a home base unit can coordinate the allocation and re-allocation of resources between the devices.

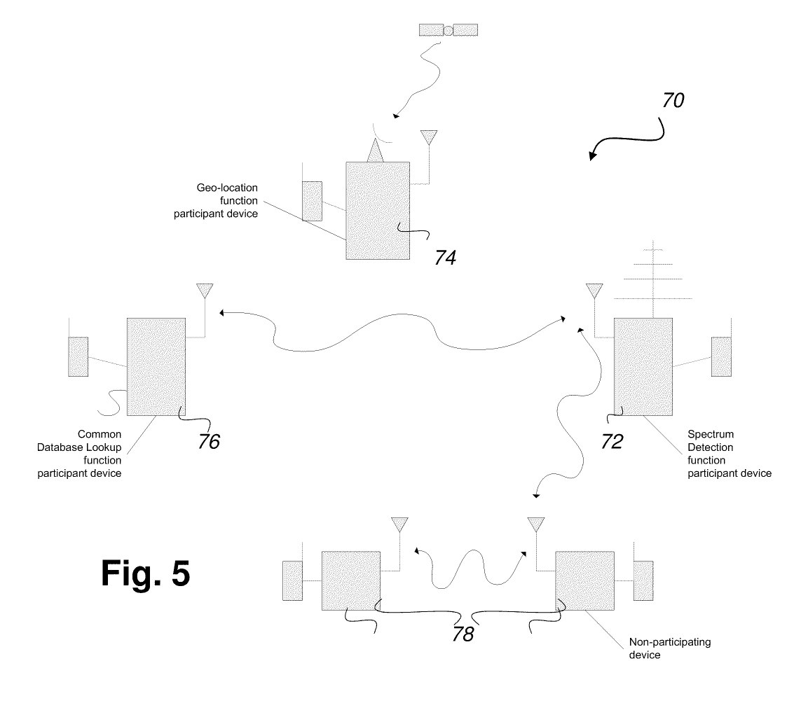

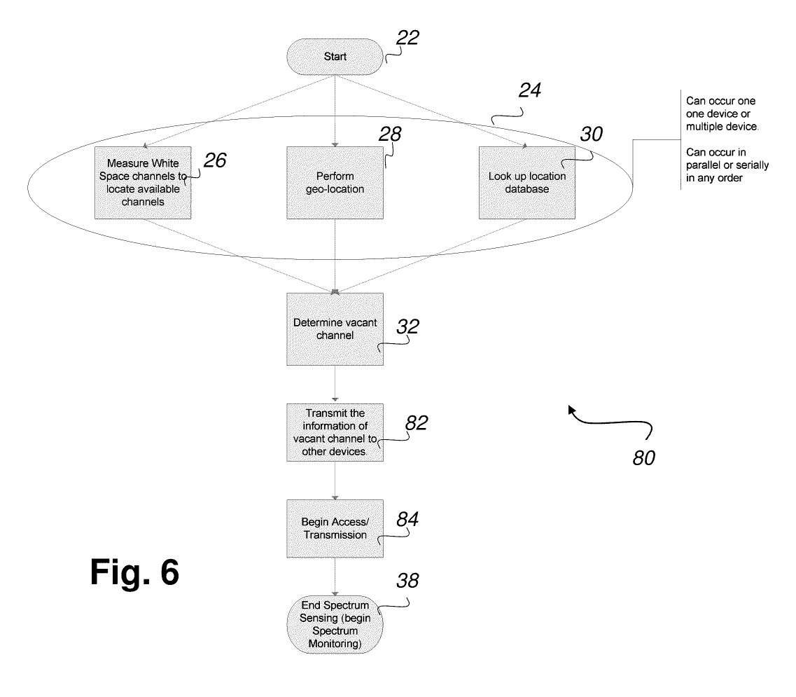

Referring to FIG. 5 there is illustrated a distributed shared spectrum sensing and monitoring process in accordance with a second embodiment of the present invention. The embodiment of FIG. 5 shows a system in which each device 72, 74 and 76 is responsible for performing a part of the method of determining whether a channel is available. Once determined, the available channel may be used by all devices including devices 78 that were not involved in determining channel availability. This figure is an example of the flow of a spectrum sensing system shown in FIG. 6 and FIG. 7. Determining the vacant channel can involve algorithm to determine which channel(s) to use. The transmission of the information can include certain messaging and protocol.

Referring to FIG. 6 there is illustrated a process for shared spectrum sensing in accordance with a third embodiment of the present invention. This figure is an example of the flow of a shared spectrum monitoring system shown in FIG. 4 and FIG. 5. The flow is similar to that shown in FIG. 2 as indicated by the use of the same reference characters for the first part of the flow chart. However, once a vacant channel has been identified at 32, that information is shared with other devices at step 82 so that the devices in the system can begin access and transmission at 84. The process includes the step of monitoring 38 to ensure that of the channel found remains available. The flow is equally valid with or without the optional step as described in FIG. 7.

Referring to FIG. 7 there is illustrated a process for shared spectrum monitoring in accordance with a fourth embodiment of the present invention. This figure is an example of the flow of a shared spectrum monitoring system shown in FIG. 4 and FIG. 5. The flow is equally valid with or without the optional step as described in FIG. 7. The flow 90 is similar to that of FIG. 3, with the addition of steps 92 and 94 to inform other devices that the channel is no longer vacant 92 and that another channel is available 94.

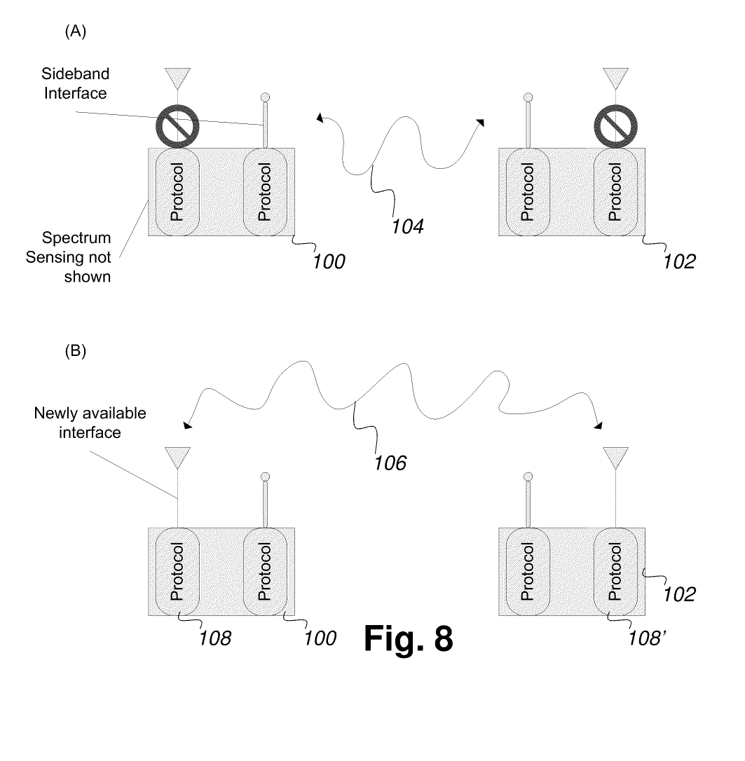

Referring to FIG. 8 there is illustrated an example of devices with sideband channel and newly available air interface with multiple protocols. This figure is an example of a system where the devices 100 and 102 communicate on an available sideband channel 104 to coordinate before the limited/restricted resource(s) is available or when the limited/restricted resource(s) 106 is/are available. Examples of sideband channels include Wi-Fi, and cellular. Examples of limited/restricted resources include white space frequencies/channels, and resources available to cognitive radios. These resources can be frequency, channels, and time. Afterwards, the devices 100 and 102 communicate with the new protocol 108 as dictated by standard. These standards can be the white space standard or cognitive radio standard.

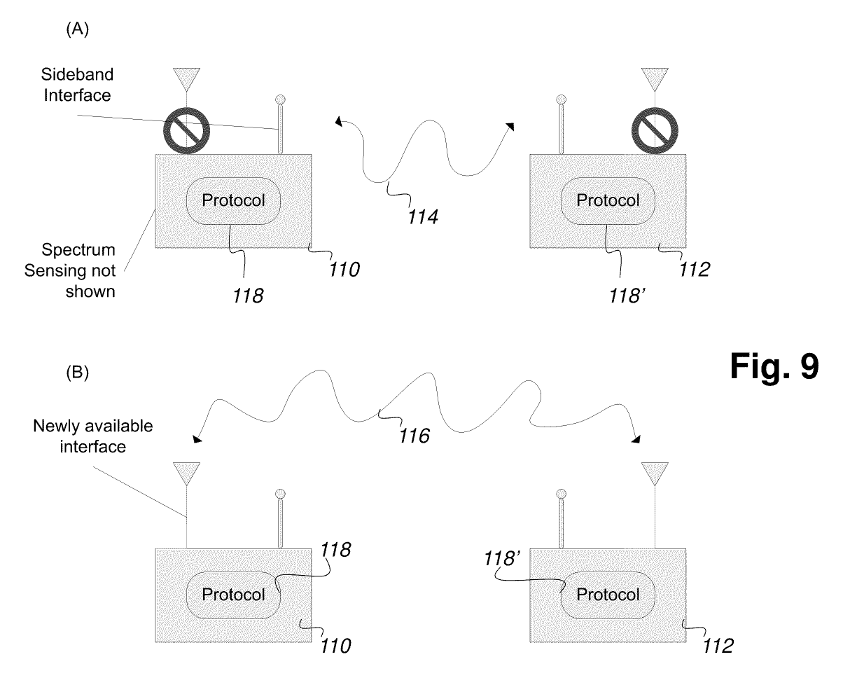

Referring to FIG. 9 there is illustrated an example of devices 110 and 112 with sideband channel 114 and newly available air interface 116 with one protocol 118. This figure is an example where the same protocol but different RF carrier frequencies bands. For example, white space standard can operate on 2.4 GHz band for the sideband communication, and then switch to white space frequency/channel after spectrum sensing and negotiation. In another example, LTE air-interface can operate on licensed spectrum then switch to the newly available resource(s) (i.e. white space). Likewise, Wi-Fi air-interface can operate in 2.4 GHz and to the newly available resource(s) with the same protocol.

The communications of the two interfaces can occur with the same protocol. As shown in FIG. 9, in scenario (A) the first interface 114 is used to coordinate the spectrum sensing information. In scenario (B), the devices 110 and 112 use the newly available channel 116 to communicate. The communication in scenarios A and B can occur utilizing the same protocol 118. Furthermore, the interface 114 can continue to be utilized even though the interface 116 is available.

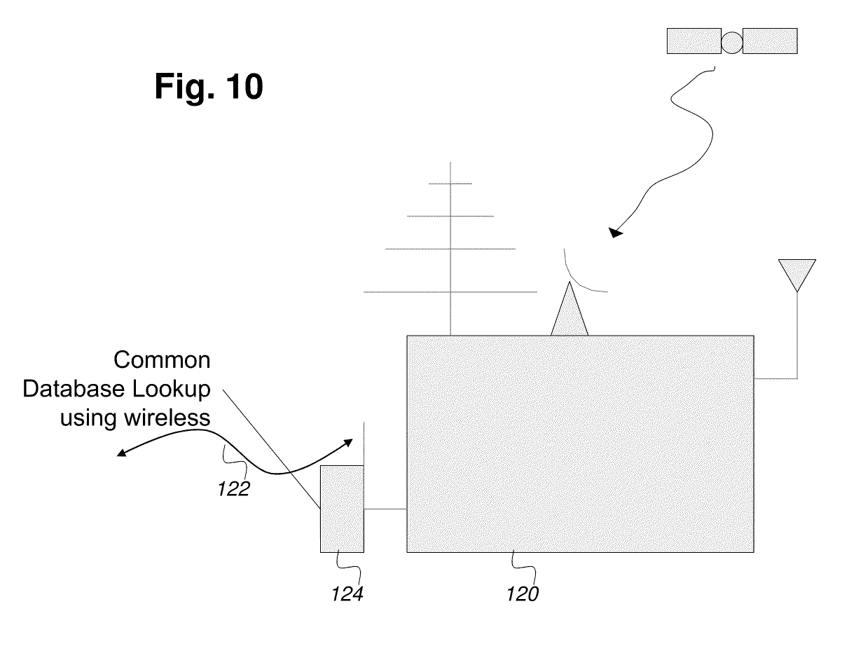

Referring to FIG. 10 there is illustrated an example of devices 120. This figure is an example of a system where the method of spectrum sensing and spectrum monitoring is different than a prior example (i.e. FIG. 1). In this example, the common database lookup is provided by a data connection via a wireless link 124. Once again, the way that each function in the spectrum sensing and spectrum monitoring is provided can be substituted for another valid way to perform the function.

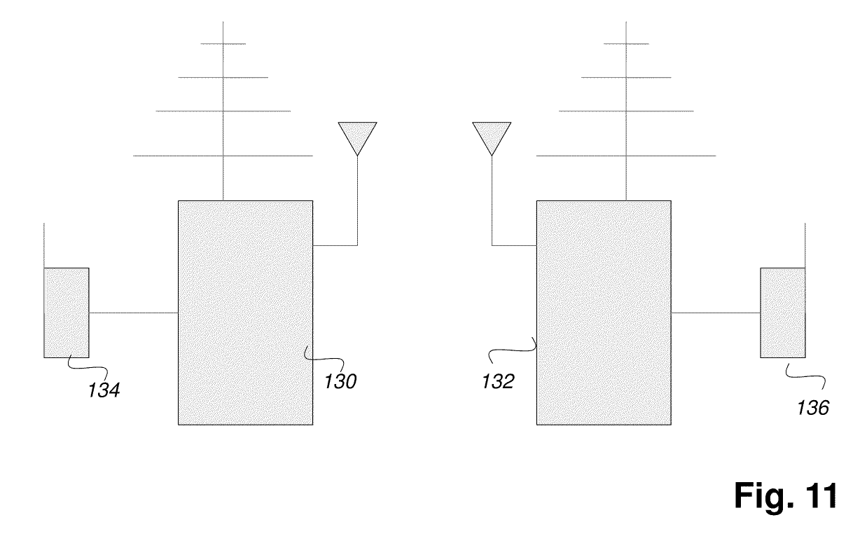

Referring to FIG. 11 there is illustrated an example of devices 130 and 132 with sideband channel 134 and 136. This figure is an example where a specific function of spectrum sensing/monitoring is shared or coordinated among a plurality of devices. In this example, both devices of the system perform spectrum detection. In this example, both devices communicate/coordinates using a sideband channel. The devices are allocated the channel list or order so that one device scans one set of channels and another device scans another set of channels. The list or order may overlap. Doing so, the scanning will occur more quickly or the results will be enhanced or cost reduced. Though shown as the spectrum detection function, any spectrum sensing function or a multiple of the functions may be allocated to multiple devices. Also, though shown to be identical, the device with the allocation of the function need not perform the function using the identical means.

Another application of the invention will be to facilitate or accelerate the spectrum sensing and spectrum monitoring functions (i.e. FIG. 11). For example, the scanning of the frequency can take a measurable amount of time. Also, geo-locations may take some measurable time. Both of these functions' performance is a function of location and channel conditions that may vary by location. The common database lookup may be bandwidth limited or may be stored on storage (e.g. disk).

The function of one or multiple of these tasks can be broken up into smaller segments with the information or results exchanged between the devices. For example, there may be two devices with the spectrum detection circuitry. These two devices coordinate such that one device scans one set of channels and the second device scans another set of channels. Its results will be exchanged (i.e. on the first, second, or potentially on a third device) to decide which channel is appropriate to utilize.

Numerous modifications, variations and adaptations may be made to the particular embodiments described above without departing from the scope patent disclosure, which is defined in the claims.

What is claimed is:

1. A system comprising:
a first device having spectrum functions for identifying vacant radio spectrum channels and a communications link to at least a second device; and
messaging module for generating a message to the second device when a vacant radio frequency channel is identified.

2. The system of claim 1 wherein the spectrum functions include a radio frequency channel activity detector.

3. The system of claim 2 wherein the radio frequency channel activity detector includes multiple channel capability.

4. The system of claim 1 wherein the spectrum functions include a locator.

5. The system of claim 4, wherein the locator includes a global positioning system (GPS) receiver.

6. The system of claim 1 wherein the spectrum functions include a database access.

7. The system of claim 6 wherein the database access is via the Internet.

8. The system of claim 1, wherein the communications link is a wired link.

9. The system of claim 8, wherein the wired link is an Ethernet port.

10. The system of claim 8, wherein the wired link via a power line.

11. The system of claim 1, wherein the communications link is a wireless link.

12. The system of claim 11, wherein the wireless link is a wireless LAN.

13. The system of claim 11, wherein the wireless link is a cellular phone channel.

14. A system comprising:
a first device having at spectrum functions and a communications link to at least a second device;
a second device having at least complementary spectrum functions;
at least one of the first and second devices having a messaging module for generating a message to any predetermined devices when a vacant radio frequency channel is identified.

15. The system of claim 14 wherein the spectrum functions include a radio frequency channel activity detector.

16. The system of claim 15 wherein the radio frequency channel activity detector includes multiple channel capability.

17. The system of claim 14 wherein the spectrum functions include a locator.

18. The system of claim 17, wherein the locator includes a global positioning system (GPS) receiver.

19. The system of claim 14 wherein the spectrum functions include a database access.

20. The system of claim 19 wherein the database access is via the Internet.

21. The system of claim 14, wherein the communications link is selected from a wired link.

22. The system of claim 21, wherein the wired link is an Ethernet port.

23. The system of claim 21, wherein the wired link via a power line.

24. The system of claim 14, wherein the communications link is selected from a wireless link.

25. The system of claim 24, wherein the wireless link is a wireless LAN.

26. The system of claim 24, wherein the wireless link is a cellular phone channel.

27. A method comprising:
sensing a radio frequency channel to determine activity;
determining location;
mapping location to existing radio frequency licenses;
determining the radio frequency channel to be available; and
sharing that the radio frequency channel is available.

28. The method of claim 27, wherein the steps of sensing, determining location and mapping are performed serially.

29. The method of claim 27, wherein the steps of sensing, determining location and mapping are performed in parallel.

30. The method of claim 27, wherein the steps of sensing, determining location and mapping are performed by one entity.

31. The method of claim 27, wherein the steps of sensing, determining location and mapping are performed by more than one entity.

32. The method of claim 27, wherein the step of sharing is performed by one entity.

33. The method of claim 27, wherein the step of sharing is performed by more than one entity.

34. The method of claim 27 wherein a home base unit performs the steps of sensing, determining location, mapping location and determining the radio frequency to be available.

35. The method of claim 34 wherein proximity of devices to the home base unit is used to determine the step of sharing that the radio frequency channel is available.

36. The method of claim 27 wherein a first protocol is used for both the step of sharing and for using the radio frequency channel that is available.

37. The method of claim 27 further comprising the step if listening on the available radio frequency channel and then is clear of a signal, transmitting on the available radio frequency channel.

38. The method of claim 27 further comprising the step of allocating radio frequency resources to a device.

39. The method of claim 38 further comprising the step of allocating alternative resources to the device.

40. The method of claim 38 further comprising the step of allocating substitute resources to the device.

41. The method of claim 38 further comprising the step of allocating additional resources to the device.

42. The method of claim 38 wherein the radio resources comprise channel bandwidth.

43. The method of claim 38 wherein the radio resources comprise codes.

44. The method of claim 38 wherein the radio resources comprise time slots.

45. The method of claim 38 wherein the radio resources comprise at least one of bandwidth, time and frequency.
